(19) United States
(12) Patent Application Publication
(10) Pub. No.: US 2004/0230995 A1
(43) Pub. Date: Nov. 18, 2004

(54) Attentiveness monitoring in multicast systems

(75) Inventors: Boaz Carmeli, Koranit (IL); John J. Duigenan, Bournemouth (GB); Gidon Gershinsky, Haifa (IL); Graham D. Wallis, West Wellow (GB)

Correspondence Address: IBM Corporation, IP Law Department, 11400 Burnet Road, Austin, TX, 78758, US

(73) Assignee: International Business Machine Corporation, Armonk, NY

(21) Appl. No.: 10/713,983

(22) Filed: Nov. 13, 2003

(30) Foreign Application Priority Data
Apr. 8, 2003 (GB) 0308037.1

(51) Int. Cl. H04N 7/173; H04L 1/18; G08C 25/02

(52) U.S. Cl. 725/90; 725/93; 714/748; 714/749

(57) ABSTRACT

A method of sending packets to a multiplicity of subscribers in a multicast subscription system includes monitoring the activity at a NACK server. The method also includes disturbing the flow of data between the sender and the subscribers. The latter may include creating a NACK generation incident in order to determine if the sender has any attentive subscribers.

### FIELD OF THE INVENTION

The present invention relates to multicast subscriber systems generally and to attentiveness monitoring therein in particular.

### BACKGROUND OF THE INVENTION

In a multicast subscription messaging system, subscribers register their interest in one or more topics. The sender performs a match of publications to interested subscribers and sends a copy of each publication to the appropriate subscribers. Messages are transmitted as multicast messages (i.e. the sender transmits a single message to a number of subscribers).

In a reliable multicast system, subscribers request retransmission of any packet that is not delivered. When a subscriber detects a gaps in the delivery sequence indicating a missing packet, the subscriber requests retransmission of the missing packet by sending a “negative acknowledgement” or NACK to the sender. To avoid the generation of a storm of NACKs when a packet goes missing, the subscribers use a NACK suppression mechanism, which operates by having each subscriber set a random back-off timer. The subscriber sends a multicast NACK packet on expiry of the timer. If a subscriber sees another subscriber's NACK packet before its own timer expires, it cancels the timer. However, the NACK suppression mechanism is optional; some systems activate it, others do not.

The following URLs, present in February 2003, describe various multicast systems and include in them sections on the NACK mechanism:

www.fag.org/rfcs/rfc3208.html;

http://www.ietf.org/internet-drafts/draft-ietf-rmt-pi-norm-05.txt

http://www.ietf.org/internet-drafts/draft-ietf-magma-msnip-01.txt

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a multicast subscription system having an attentiveness monitor, constructed and operative in accordance with a preferred embodiment of the present invention;

FIG. 2 is a flow chart illustration of a method of monitoring attentiveness, in accordance with a preferred embodiment of the present invention and implemented by the attentiveness monitor of FIG. 1;

FIGS. 3 and 4 are schematic illustrations of a pending queue and a sending queue, illustrating two alternative methods of changing the packet sequence; and

FIG. 5 is a schematic illustration of a further method of monitoring attentiveness, in accordance with a further preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that the NACK system, present in most modern multicast data networks, naturally provides an indication of attentiveness. Any subscriber not listening to the sender will not send a NACK when a packet goes missing while a subscriber who is actively listening to the sender will send a NACK. If the NACK suppression mechanism is activated, the subscriber will send a NACK only if no one else already did.

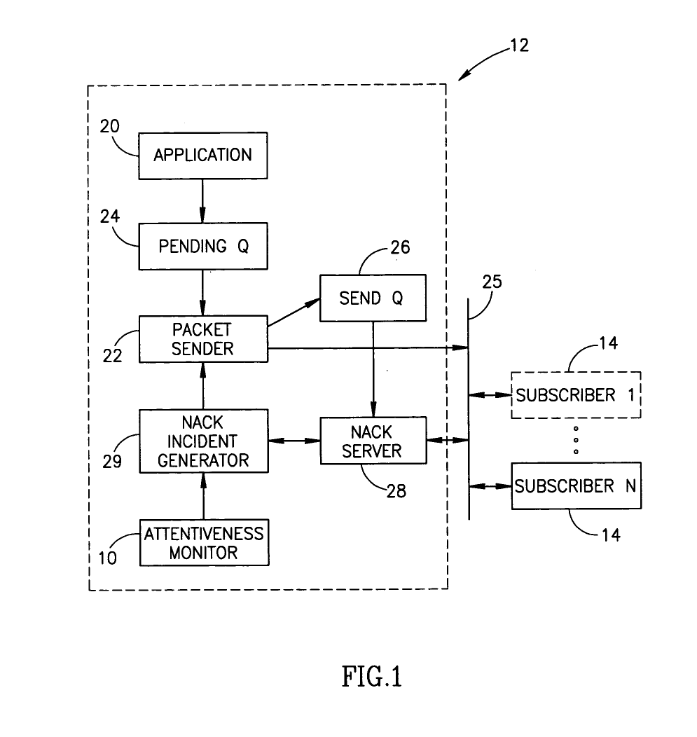

Reference is now made to FIG. 1, which illustrates an attentiveness monitor 10, constructed and operative in accordance with an embodiment of the present invention and operating within a data network. In accordance with an embodiment of the present invention, attentiveness monitor 10 may form part of a sender 12 and may determine whether or not there are any active subscribers 14 paying attention to the messages sent by sender 12. In FIG. 1, N subscribers 14 are shown, of which subscriber 1 is no longer active (as indicated by the dashed lines).

In accordance with an embodiment of the present invention, attentiveness monitor 10 may monitor receipt of negative acknowledgements (NACKs) to determine if there are any attentive subscribers 14. An attentive subscriber 14, such as subscriber N of FIG. 1, may be one who complains that a data packet has gone missing. Subscriber 1 might not complain about the missing packet since he is no longer listening to the messages from sender 12.

FIG. 1 illustrates the general elements of an exemplary system with which attentiveness monitor 10 operates. The system of FIG. 1 is an example only; the present invention may operate in any system which has a NACK mechanism.

In normal operation, an application 20 may provide data packets to be transmitted to a pending queue 24 which, in turn, provides them to a packet sender 22. Packet sender 22 may produce a transmission packet by wrapping the data packets with transmission headers and footers. At some point, the packet sender 22 may also transmit the packets on a network 25, after which, packet sender 22 may place the sent packets in a sent packet queue 26.

If an attentive subscriber 14 does not receive a packet, it may transmit a NACK to a NACK server 28, requesting a copy of the missing packet. NACK server 28 may then take a copy of the missing packet from sent queue 26 and may retransmit the missing packet. If the system has activated the NACK suppression mechanism, then only one of the attentive subscribers 14 may send a NACK. The remaining subscribers do not bother to send a NACK.

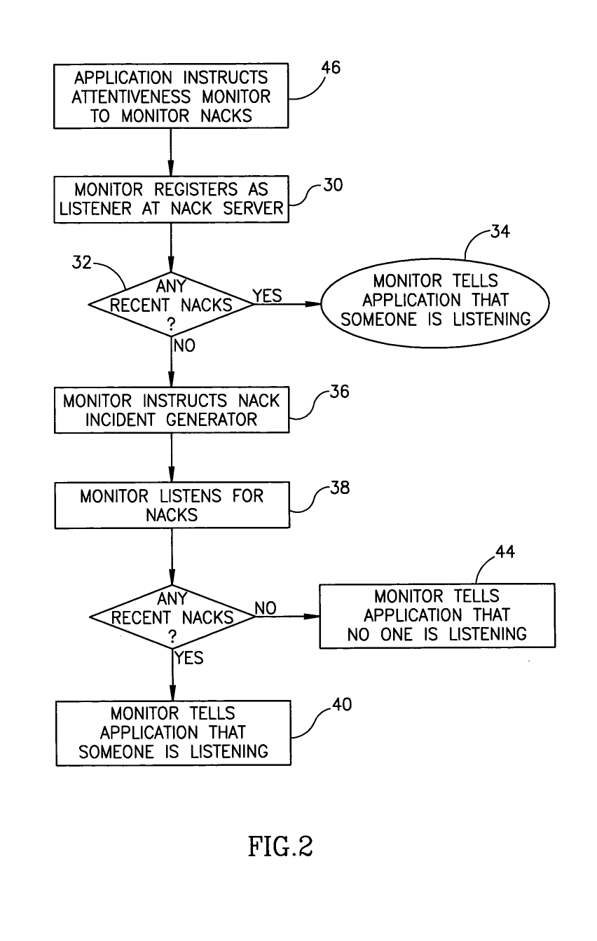

In accordance with an embodiment of the present invention, and as shown in FIG. 2 to which reference is now made, attentiveness monitor 10 may be registered (step 30) as a listener at NACK server 28 and may thus monitor the receipt of NACKs. As checked in step 32, as long as one NACK has recently been received (indicating that there is at least one attentive subscriber 14), attentiveness monitor 10 may indicate (step 34) to application 20 that there are interested subscribers 14. “Recently” may have any definition. An exemplary definition might be “within the last 5-10 seconds”.

However, in the absence of any NACK packets, attentiveness monitor 10 may disturb (step 36) the data flow so as to cause the subscribers to send NACKs (a “NACK generation incident”). For this purpose, attentiveness monitor 10 may operate with a NACK incident generator 29 (FIG. 1) who may disturb the data flow in any suitable manner. In one embodiment, NACK incident generator 29 may disturb the data flow by changing the sequence of packets.

In one embodiment, NACK incident generator 29 may disturb the packet sequence by skipping a packet (e.g. sender 12 may send packets n−1, n+1, but may skip packet n). Attentive subscribers 14, if there are any, may detect the gap, and may each send a NACK. Alternatively, if NACK suppression is activated, only one of the subscribers 14 may send a NACK. Upon receipt of a NACK, packet sender 22 may send packet n (either to each one who sent a NACK or, if NACK suppression is activated, to all subscribers), so subscribers 14 fill the gap. Attentiveness monitor 10 may monitor (step 38, FIG. 2) the receipt of the NACKs and may indicate (step 40) to application 20 that there are interested subscribers 14, as long as the NACK was received “recently” (as checked in step 42). However, if, at this point, no NACKs were received, then attentiveness monitor 10 may indicate (step 44) to application 20 that there are no interested subscribers.

Attentiveness monitor 10 may operate periodically or may operate upon instruction (step 46) from application 20.

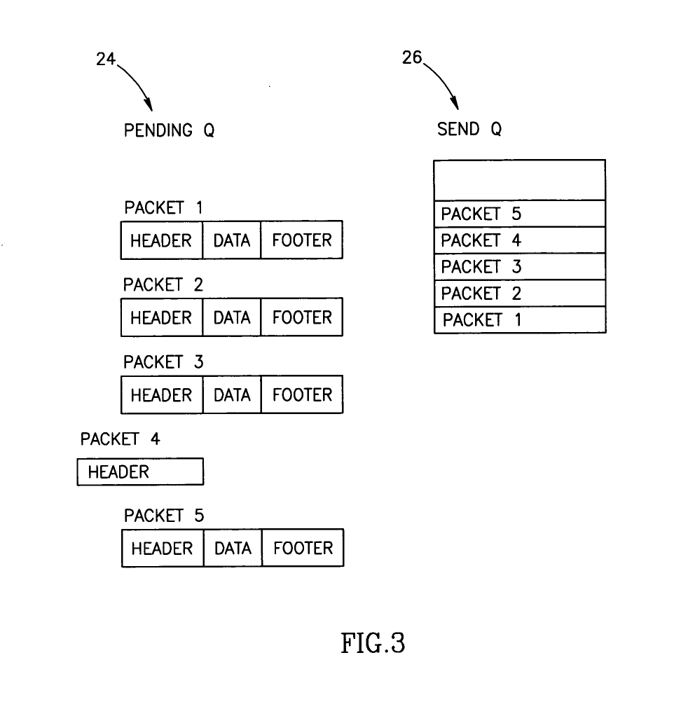

Another way to disturb the data flow is shown in FIG. 3, to which reference is now made. FIG. 3 shows the pending queue 24 and the sent queue 26. Pending queue 24 shows each packet in full; that is, each packet has a header section, a data section and a footer section. In this embodiment, packet sender 22 may generate a packet, for example packet 4, with only a header. Packet sender 22 may transmit packets 1-3, placing them in sent queue 26. Packet sender 22 may not transmit packet 4 (and thus, FIG. 3 shows it to the side of pending queue 24); however, packet sender 22 may place packet 4 into sent queue 26. At least one listening subscriber 14 may send a NACK since packet 4 was never received. In response, packet sender 22 may then transmit packet 4 either to each subscriber or to all subscribers, depending on the status of the NACK suppression mechanism.

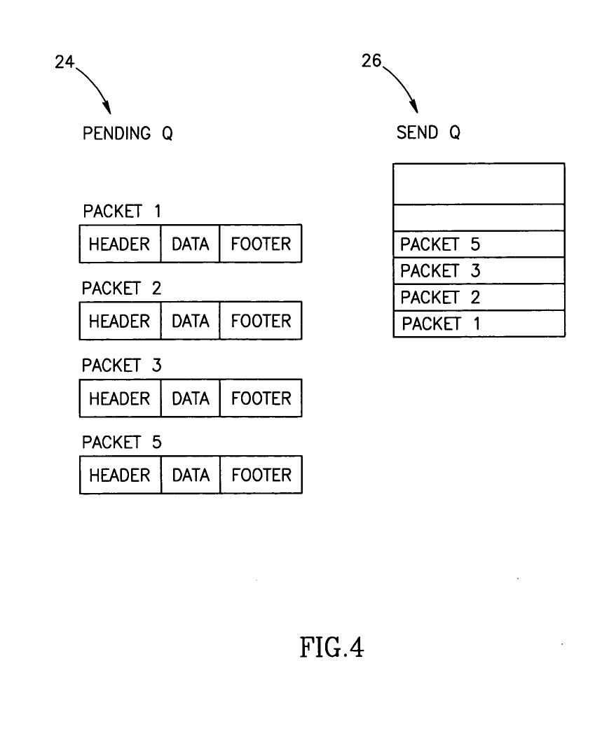

Another way to change the packet sequence is to artificially increment the sequence number relative to the sequence of packets that actually need to be sent. This is shown in FIG. 4, to which reference is now made. In the example of FIG. 4, monitor 10 may send packets 1-3. The next packet is then 5, rather than 4 as it should be. Both pending queue 24 and sent queue 26 have the same set of packets. Upon receipt of a NACK from a listening subscriber 14, packet sender 22 may admit that there was no packet with sequence number 4. This mechanism may occur with any packet n.

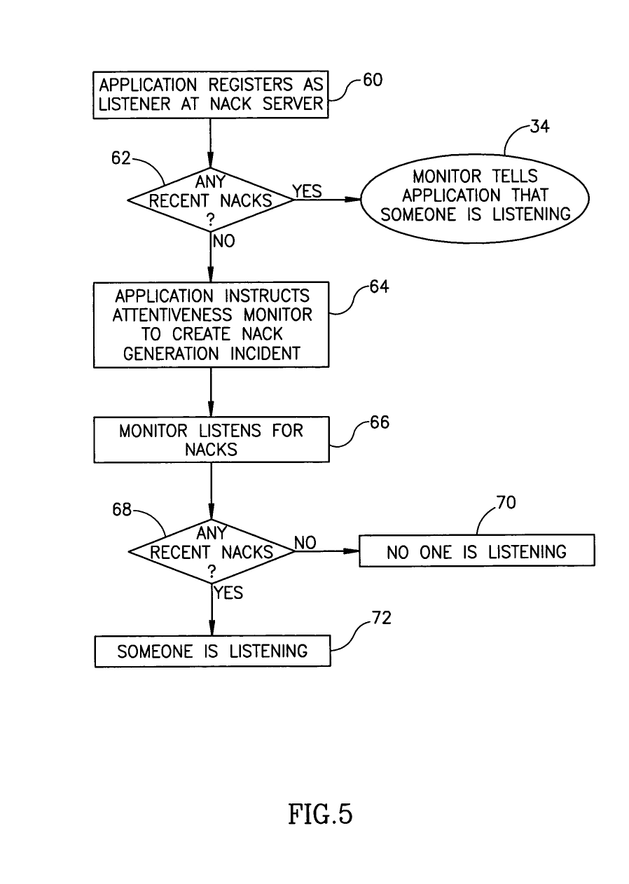

In accordance with a further embodiment of the present invention, application 20 may monitor the activity at NACK server 28. In this embodiment, shown in FIG. 5 to which reference is now made, application 20 may register (step 60) at NACK server 28. If no NACKs have been received recently (as checked in step 62), then application 20 may instruct (step 64) attentiveness monitor 10 to create a NACK generation incident. Attentiveness monitor 10 may skip a packet, as per the first embodiment, or may increment the packet sequence, as per the second embodiment, or may disturb the data flow in any other manner that will generate feedback from the subscriber. Application 20 may then monitor the activity at NACK server 28 to determine if any one is listening (steps 66-72).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A sender in a multicast subscription system having a multiplicity of subscribers, the sender comprising:
a negative acknowledge (NACK) server; and
an attentiveness monitor which monitors the activity at said NACK server.

2. A sender according to claim 1 and also comprising a NACK incident generator which disturbs the flow of data between said sender and said subscribers.

3. A sender according to claim 2 and wherein said NACK incident generator alters the sent and pending queues.

4. A sender according to claim 3 and wherein said NACK incident generator places a packet in said sent queue which was never transmitted.

5. A sender according to claim 3 and wherein said NACK incident generator alters the packet sequence number.

6. A sender according to claim 3 and wherein said NACK incident generator increments the sequence number relative to the sequence of packets that actually need to be sent.

7. A sender according to claim 1 and wherein said attentiveness monitor determines whether or not there are attentive subscribers from the activity at said NACK server.

8. A sender in a multicast subscription system having a multiplicity of subscribers, the sender comprising:
a negative acknowledge (NACK) server; and
a NACK incident generator which disturbs the flow of data between said sender and said subscribers.

9. A sender according to claim 8 and wherein said NACK incident generator alters the sent and pending queues.

10. A sender according to claim 8 and wherein said NACK incident generator places a packet in said sent queue which was never transmitted.

11. A sender according to claim 8 and wherein said NACK incident generator alters the packet sequence number.

12. A sender according to claim 8 and wherein said NACK incident generator increments the sequence number relative to the sequence of packets that actually need to be sent.

13. A method of sending packets to a multiplicity of subscribers in a multicast subscription system, the method comprising:
monitoring the activity at a NACK server.

14. A method according to claim 13 and wherein said monitoring includes determining whether or not there are attentive subscribers from the activity at said NACK server.

15. A method according to claim 13 and also comprising disturbing the flow of data between said sender and said subscribers.

16. A method according to claim 15 and wherein said disturbing comprises altering the sent and pending queues.

17. A method according to claim 15 and wherein said disturbing comprises placing a packet in said sent queue which was never transmitted.

18. A method according to claim 15 and wherein said disturbing comprises altering the packet sequence number.

19. A method according to claim 15 and wherein said disturbing comprises incrementing the sequence number relative to the sequence of packets that actually need to be sent.

20. A method of sending packets to a multiplicity of subscribers in a multicast subscription system, the method comprising:
disturbing the flow of data between said sender and said subscribers.

21. A method according to claim 20 and wherein said disturbing comprises altering the sent and pending queues.

22. A method according to claim 20 and wherein said disturbing comprises placing a packet in said sent queue which was never transmitted.

23. A method according to claim 20 and wherein said disturbing comprises altering the packet sequence number.

24. A method according to claim 20 and wherein said disturbing comprises incrementing the sequence number relative to the sequence of packets that actually need to be sent.

25. A method of sending packets to a multiplicity of subscribers in a multicast subscription system, the method comprising:
having packets in a sent queue which were never in a pending queue.

26. A method of sending packets to a multiplicity of subscribers in a multicast subscription system, the method comprising:
creating a NACK generation incident in order to determine if said sender has any attentive subscribers.

27. A computer product readable by a machine, tangibly embodying a program of instructions executable by the machine to perform method steps for transmission of packets to a multiplicity of subscribers in a multicast subscription system, said method steps comprising:
monitoring the activity at a NACK server.

28. A product according to claim 27 and wherein said monitoring includes determining whether or not there are attentive subscribers from the activity at said NACK server.

29. A product according to claim 27 and also comprising disturbing the flow of data between said sender and said subscribers.

30. A product according to claim 29 and wherein said disturbing comprises altering the sent and pending queues.

31. A product according to claim 29 and wherein said disturbing comprises placing a packet in said sent queue which was never transmitted.

32. A product according to claim 29 and wherein said disturbing comprises altering the packet sequence number.

33. A product according to claim 29 and wherein said disturbing comprises incrementing the sequence number relative to the sequence of packets that actually need to be sent.

34. A computer product readable by a machine, tangibly embodying a program of instructions executable by the machine to perform method steps for transmission of packets to a multiplicity of subscribers in a multicast subscription system, said method steps comprising:
disturbing the flow of data between said sender and said subscribers.

35. A product according to claim 34 and wherein said disturbing comprises altering the sent and pending queues.

36. A product according to claim 34 and wherein said disturbing comprises placing a packet in said sent queue which was never transmitted.

37. A product according to claim 34 and wherein said disturbing comprises altering the packet sequence number.

38. A product according to claim 34 and wherein said disturbing comprises incrementing the sequence number relative to the sequence of packets that actually need to be sent.

39. A computer product readable by a machine, tangibly embodying a program of instructions executable by the machine to perform method steps for transmission of packets to a multiplicity of subscribers in a multicast subscription system, said method steps comprising:
having packets in a sent queue which were never in a pending queue.

40. A computer product readable by a machine, tangibly embodying a program of instructions executable by the machine to perform method steps for transmission of packets to a multiplicity of subscribers in a multicast subscription system, said method steps comprising:
creating a NACK generation incident in order to determine if said sender has any attentive subscribers.
